(19) United States
(12) Patent Application Publication
(10) Pub. No.: US 2011/0234778 A1
(43) Pub. Date: Sep. 29, 2011

(54) Remote Controller and Related System

(75) Inventor: Che-Ya Chang, Hsin-Chu (TW)

(73) Assignee: MODIOTEK CO., LTD., Hsinchu (TW)

(21) Appl. No.: 12/821,589

(22) Filed: Jun. 23, 2010

Related U.S. Application Data
(60) Provisional application No. 61/317,716, filed on Mar. 26, 2010.

(51) Int. Cl. H04N 5/44; H04N 7/18; H04L 17/02

(52) U.S. Cl. 348/61; 341/176; 348/734; 348/E07.085; 348/E05.096

(57) ABSTRACT

A remote controller including a wireless communication module, an image capture module and a host processor is provided. The wireless communication module is for communicating with a be-controlled appliance. The image capture module is for photographing and generating an image signal. The host processor is for performing a remote control function to control the be-controlled appliance, and processing the image signal to transmit to the be-controlled appliance via the wireless communication module to be post-processed.

This application claims the benefit of U.S. provisional application Ser. No. 61/317,716, filed Mar. 26, 2010, the subject matter of which is incorporated herein by reference.

### BACKGROUND OF THE INVENTION

1. Field of the Invention

The invention relates in general to a remote controller and a related system, and more particularly to a remote controller and a related system having high convenience.

2. Description of the Related Art

Along with the time progressing, various electrical appliances products are designed for consumers' convenience more closely, and a remote controller is one of the convenient use way. The modern appliances, such as a TV, a set-top box, a Blu-ray Disc player and Audio, remote controllers are attached for users' unrestrained use of the above appliances. However, simple remote control functions of the conventional remote controllers can not satisfy users' needs after the ideas of media centers and digital living network appliances are proposed. How to provide more complete and convenient functions to meet users' needs is one of important issues of the industry.

### SUMMARY OF THE INVENTION

The invention is directed to a remote controller and a related system, capable of either controlling a be-controlled appliance or providing various functions and enhancing users' convenience by integrating various peripheral modules.

According to a first aspect of the present invention, a remote controller including a wireless communication module, an image capture module and a host processor is provided. The wireless communication module is for communicating with a be-controlled appliance. The image capture module is for photographing and generating an image signal. The host processor is for performing a remote control function to control the be-controlled appliance, and processing the image signal to transmit to the be-controlled appliance via the wireless communication module to be post-processed.

According to a second aspect of the present invention, a remote controller including a wireless communication module, a sound input port and a host processor is provided. The wireless communication module is for communicating with a be-controlled appliance. The sound input port is for receiving a sound input signal. The host processor is for performing a remote control function to control the be-controlled appliance, and processing the sound input signal to transmit to the be-controlled appliance via the wireless communication module to be post-processed.

According to a third aspect of the present invention, a remote controller including a wireless communication module, a host processor and a sound output port is provided. The wireless communication module is for communicating with a be-controlled appliance and receiving a sound playing signal form the be-controlled appliance. The host processor is for performing a remote control function to control the be-controlled appliance, and processing the sound playing signal. The sound output port is for outputting the sound playing signal processed by the host processor to a sound playing element.

According to a fourth aspect of the present invention, a remote control system including a be-controlled appliance and a remote controller is provided. The remote controller is for remote controlling the be-controlled appliance, and includes a wireless communication module and a host processor. The wireless communication module is for communicating with a be-controlled appliance. The host processor is for performing a remote control function to control the be-controlled appliance. The remote controller further comprises at least one of an image capture module, a sound input port and a sound output port. The image capture module is for photographing and generating an image signal, the sound input port is for receiving a sound input signal, and the sound output port is for outputting a sound playing signal to a sound playing element. The host processor is further for processing at least one of the image signal, the sound input signal and the sound playing signal, and transmitting at least one of the image signal, the sound input signal and the sound playing signal to the be-controlled appliance via the wireless communication module to be post-processed.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration of an example of a remote controller according to a preferred embodiment of the invention.

FIG. 2 is a schematic illustration of another example of a remote controller according to a preferred embodiment of the invention.

FIG. 3 is a schematic illustration of an extra example of a remote controller according to a preferred embodiment of the invention.

FIG. 4 is a schematic illustration of a remote control system according to a preferred embodiment of the invention.

### DETAILED DESCRIPTION OF THE INVENTION

The invention provides a remote controller and a related system, capable of either controlling a be-controlled appliance or providing various functions and enhancing users' convenience by performing simple processing by a host processor and integrating data of various peripheral modules.

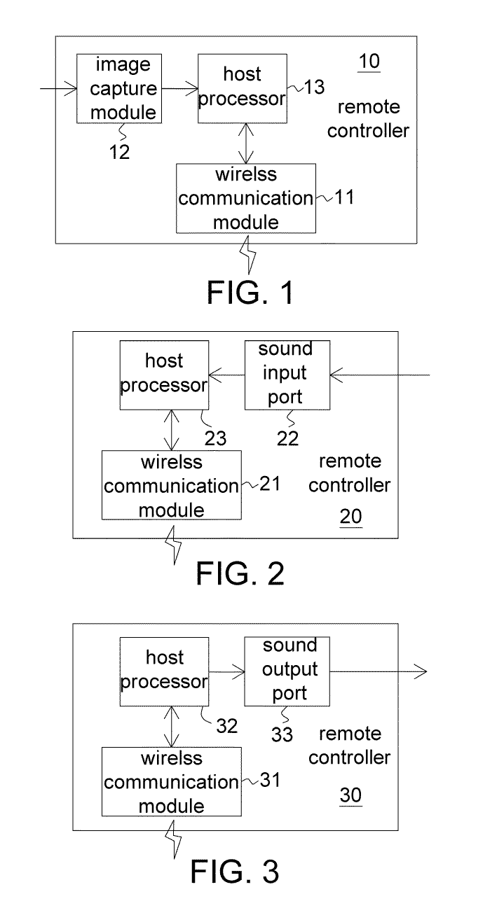

The invention provides a remote controller. Referring to FIG. 1, a schematic illustration of an example of a remote controller according to a preferred embodiment of the invention is shown. The remote controller 10 includes a wireless communication module 11, an image capture module 12 and a host processor 13. The wireless communication module 11 is for communicating with a be-controlled appliance. The image capture module 12 is for photographing and generating an image signal. The host processor 13 is for performing a remote control function to control the be-controlled appliance, and processing the image signal to transmit to the be-controlled appliance via the wireless communication module 11 to be post-processed. In addition, the image capture module 12 is also for video recording as images are captured continuously.

The invention provides another remote controller. Referring to FIG. 2, a schematic illustration of another example of a remote controller according to a preferred embodiment of the invention is show. The remote controller 20 includes a wireless communication module 21, a sound input port 22 and a host processor 23. The wireless communication module 21 is for communicating with a be-controlled appliance. The sound input port 22 is for receiving a sound input signal. The host processor 23 is for performing a remote control function to control the be-controlled appliance, and processing the sound input signal to transmit to the be-controlled appliance via the wireless communication module 21 to be post-processed.

The invention provides an extra remote controller. Referring to FIG. 3, a schematic illustration of an extra example of a remote controller according to a preferred embodiment of the invention is show. The remote controller 30 includes a wireless communication module 31, a host processor 32 and a sound output port 33. The wireless communication module 31 is for communicating with a be-controlled appliance and receiving a sound playing signal form the be-controlled appliance. The host processor 32 is for performing a remote control function to control the be-controlled appliance, and processing the sound playing signal. The sound output port 33 is for outputting the sound playing signal processed by the host processor 32 to a sound playing element.

Take a remote control system integrating functions of above remote controllers as being exemplified hereinafter. However, it should be taken notice that the novel functions of the remote controller provided in the above embodiment not only could be existed alone, but also could be integrated with each other in the remote control system, and it is not limited thereto.

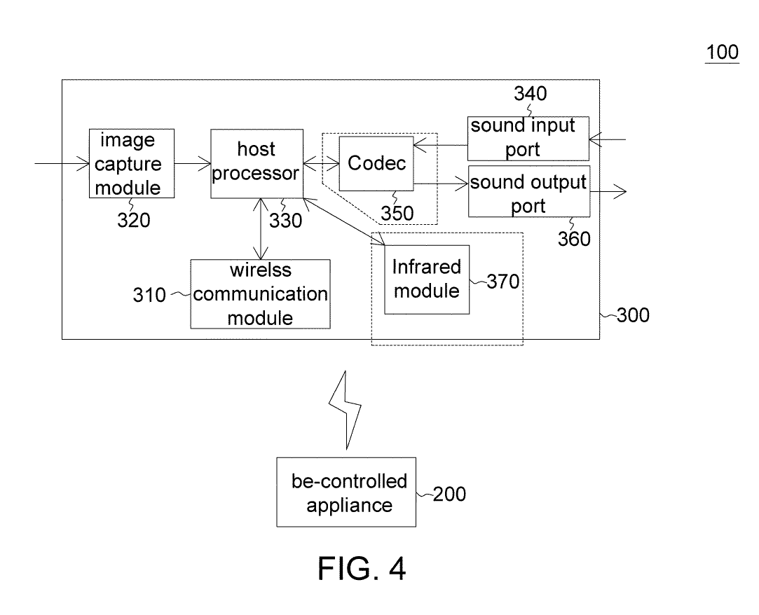

Referring to FIG. 4, a schematic illustration of a remote control system according to a preferred embodiment of the invention is shown. The remote control system 100 includes a be-controlled appliance 200 and a remote controller 300. The to-be controlled appliance 200 is, for example, a TV, a set-top box, or a Blu-ray Disc player, and it is not limited thereto. The to-be controlled appliance 200 can be any be-controlled appliance which can be controlled by a remote controller. The remote controller 300 is for remote controlling the be-controlled appliance 200. The be-controlled appliance 200 is able to access Internet, so that the remote controller 300 can control the be-controlled appliance 200 to connect the Internet or a local area network to perform data transmission.

The remote controller 300 includes a wireless communication module 310, an image capture module 320, a host processor 330, a sound input port 340, a Codec 350, a sound output port 360 and an Infrared module 370. The Codec 350 and the Infrared module 370 are optional elements. The wireless communication module 310 is for communicating with the be-controlled appliance 200. The image capture module 320, including an image sensor, lens and related elements, for example, is for photographing and generating an image signal. Users are able to utilize the remote controller 300 to photograph, to record video, or to participate in a video conference without a webcam. The corresponding image or video, the image signal generated by the image capture module 320, is transmitted to the host processor 330.

The host processor 330 is able to perform the remote control function to control the be-controlled appliance 200 via the wireless communication module 310. In addition, the host processor 330 is also able to perform the remote control function to control the be-controlled appliance 200 via the Infrared module 370, and it is not limited thereto. The host processor 330 performs an initial simple processing on the image signal outputted by the image capture module 320. For example, the host processor 330 transforms the image signal into an image packet. Thereafter, the host processor 330 transmits the processed image signal to be-controlled appliance 200 via the wireless communication module 310 to be post-processed, such as image processing or transmitting to the network. Therefore, owing to the above-mentioned function of the remote controller, users are able to photograph, to record video, or to participate in a video conference without an additional webcam to attach to the be-controlled appliance 200, thereby reducing users' expenditure and enhancing users' convenience.

Take examples for further explanation. When a user sits on a sofa in the living room, the video camera on the TV merely captures smaller images at a long distance, and has disadvantages to capture images of specific objects at specific angles. However, due to the light and portable remote controller 300, the image capture module 320 can approach users very closely to obtain clear images/video, and the angles to capture images are easily controlled to rapidly capture images of the to-be-photographed object.

In addition, the sound input port 340 is for receiving a sound input signal, such as sound/vocal input from a microphone. If the sound input signal is an analog signal, the remote controller 300 can utilize a sound analog to digital converter built in the Codec 350 to convert the analog sound input signal into a digital sound input signal. The host processor 330 performs a simple processing on the sound input signal. For example, the host processor 330 transforms the sound input signal into a sound packet. The host processor 330 transmits the processed sound input signal to the be-controlled appliance 200 via the wireless communication module 310 to be post-processed. Therefore, owing to the above-mentioned function of the remote controller, users are able to sing karaoke or to perform functions such as web phone (ex. Skype), thereby reducing users' cost and enhancing users' convenience.

Take examples for further explanation. When a user would like to transmit a sound input signal, the user usually buys a wireless microphone. Hence, unnecessary costs occur and a socket for the microphone has to been set up at the be-controlled appliance 200. However, users do not need to buy the wireless microphone by using the remote controller 300 of the disclosed embodiment. Users' costs are reduced, and the be-controlled appliance 200 do not need to have an additional socket for the wireless microphone, thus it is convenient for use.

In addition, the wireless communication module 310 is able to receive a sound playing signal form the be-controlled appliance 200, the sound playing signal processed by the host processor 330. If the sound playing signal is a digital signal, the sound digital to analog converter built in the Codec 350 can be utilized to convert the digital sound playing signal into an analog sound playing signal. The sound output port 360 outputs the sound playing signal processed by the host processor 330 to a sound playing element, such as a headphone. Therefore, owing to the above-mentioned function of the remote controller, users are able to perform web phone functions without buying an additional headphone, or to listen music quietly without disturbing others and a long distance lengthened wired headphone, thereby not only reducing users' cost but also enhancing users' convenience.

The remote controller and the related system disclosed in the embodiment of the invention utilize a host processor to perform an initial simple processing on data so as to integrate various peripheral modules, and the simply processed data are wirelessly transmitted to a be-controlled appliance to be post-processed. Hence, the remote controller is capable of either controlling the be-controlled appliance or providing various functions corresponding to the various peripheral modules. Consequently, users can enjoy various functions without buying additional devices, thereby not only reducing users' cost but also enhancing users' convenience.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A remote controller, comprising:
a wireless communication module for communicating with a be-controlled appliance;
an image capture module for photographing and generating an image signal; and
a host processor for performing a remote control function to control the be-controlled appliance, and processing the image signal to transmit to the be-controlled appliance via the wireless communication module to be post-processed.

2. The remote controller according to claim 1, further comprising:
a sound input port for receiving a sound input signal, which is processed by the host processor and then transmitted to the be-controlled appliance via the wireless communication module to be post-processed.

3. The remote controller according to claim 1, wherein the wireless communication module receives a sound playing signal, and the sound playing signal is processed by the host processor, the remote controller further comprises:
a sound output port for outputting the sound playing signal processed by the host processor to a sound playing element.

4. The remote controller according to claim 1, wherein the host processor is further for performing the remote control function to control the be-controlled appliance via the wireless communication module.

5. The remote controller according to claim 1, wherein the be-controlled appliance is a TV, a set-top box or a Blu-ray Disc player.

6. The remote controller according to claim 1, wherein the image capture device is also for video recording as images are captured continuously.

7. A remote controller, comprising:
a wireless communication module for communicating with a be-controlled appliance;
a sound input port for receiving a sound input signal; and
a host processor for performing a remote control function to control the be-controlled appliance, and processing the sound input signal to transmit to the be-controlled appliance via the wireless communication module to be post-processed.

8. The remote controller according to claim 7, further comprising a sound output port, wherein the wireless communication module receives a sound playing signal from the be-controlled appliance, and the sound playing signal is processed by the host processor and outputted to a sound playing element via the sound output port.

9. The remote controller according to claim 7, wherein the host processor is further for performing the remote control function to control the be-controlled appliance via the wireless communication module.

10. The remote controller according to claim 7, wherein the be-controlled appliance is a TV, a set-top box or a Blu-ray Disc player.

11. A remote controller, comprising:
a wireless communication module for communicating with a be-controlled appliance and receiving a sound playing signal form the be-controlled appliance;
a host processor for performing a remote control function to control the be-controlled appliance, and processing the sound playing signal; and
a sound output port for outputting the sound playing signal processed by the host processor to a sound playing element.

12. The remote controller according to claim 11, wherein the host processor is further for performing the remote control function to control the be-controlled appliance via the wireless communication module.

13. The remote controller according to claim 11, wherein the be-controlled appliance is a TV, a set-top box or a Blu-ray Disc player.

14. A remote control system, comprising:
a be-controlled appliance; and
a remote controller for remote controlling the be-controlled appliance, comprising:
a wireless communication module for communicating with a be-controlled appliance; and
a host processor for performing a remote control function to control the be-controlled appliance;
wherein the remote controller further comprises at least one of an image capture module, a sound input port and a sound output port, the image capture module for photographing and generating an image signal, the sound input port for receiving a sound input signal, the sound output port for outputting a sound playing signal to a sound playing element, and the host processor is further for processing at least one of the image signal, the sound input signal and the sound playing signal, and transmitting at least one of the image signal, the sound input signal and the sound playing signal to the be-controlled appliance via the wireless communication module to be post-processed.

15. The remote control system according to claim 14, wherein the host processor is further for performing the remote control function to control the be-controlled appliance via the wireless communication module.

16. The remote control system according to claim 14, wherein the remote controller further comprises an Infrared module, and the host processor performs the remote control function to control the be-controlled appliance via the Infrared module.

17. The remote control system according to claim 14, wherein the be-controlled appliance is a TV, a set-top box or a Blu-ray Disc player.

18. The remote control system according to claim 14, wherein the image capture device is also for video recording as images are captured continuously.
